(19) United States
(12) Patent Application Publication
(10) Pub. No.: US 2014/0129208 A1
(43) Pub. Date: May 8, 2014

(54) ELECTRONIC TRANSLATING SYSTEM

(71) Applicant: Luke Brown, Sunrise, FL (US)

(72) Inventor: Luke Brown, Sunrise, FL (US)

(21) Appl. No.: 13/672,586

(22) Filed: Nov. 8, 2012

(51) Int. Cl. G06F 17/28

(52) U.S. Cl. CPC G06F 17/28
USPC 704/3

(57) ABSTRACT

A system for translating a message. The system for translating a message includes a computer and a software program. The software program automatically receives and translates a message sent from a remote computer to a selected language. The software also translates outgoing messages to the remote computer.

### BACKGROUND OF THE INVENTION

The present invention relates to a translating system and, more particularly, to an electronic translating system.

Currently, due to growing technology, people across the world have a desire and need to communicate with one another. However, two people living in different countries may speak a different language, which poses a problem with communication.

### SUMMARY OF THE INVENTION

To remedy the language barrier, people may purchase expensive programs to translate messages or hire a personal translator. However, both of these methods do not provide a seamless message communication with a person that speaks a different language.

As can be seen, there is a need for a system for seamless bilingual communication between remote individuals.

In one aspect of the present invention, a system for translating messages, comprising: a machine; and a program product comprising machine-readable program code for causing, when executed, the machine to perform the following process steps: receiving a message from a remote computer; providing the message to a user; prompting the user to select a language translation preference; receiving the language translation preference as a selected language; translating the received message into the selected language; receiving a new message from the user; automatically translating the new message into the selected language; and sending the new message translated into the selected language to the remote computer.

In another aspect of the present invention, the program product further causes the machine to automatically cut and paste at least one of the received message and the new message into a translation program.

In another aspect of the present invention, the program product further causes the machine to provide a section A data field, a section B data field, and a section C data field.

In another aspect of the present invention, the section A data field comprises a translate button, the section B data field comprises a send button, and the section C data field comprises a translate button.

In another aspect of the present invention, the program product further causes the machine to: display the received message in the section A data field; prompt the user to select the translate button in the section A data field; receive a translate command from the user; cut and paste the received message into the translation program, wherein the received message is translated into a translated message; and cut and paste the translated message into the section B data field wherein the user views the translated message.

In another aspect of the present invention, the program product further causes the machine to: receive the new message from the user in the section C data field; prompt the user to select the translate button in the section C data field; cut and paste said new message into the translation program, wherein the new message is translated into a translated new message; and cut and paste the new translated message into the section B data field wherein the user views the translated message.

In another aspect of the present invention, the program product further causes the machine to: prompt the user to select the send button in the section B data field; and send the translated message to the remote computer.

In another aspect of the present invention, the program product further causes the machine to: display an advanced setting button, wherein the advanced setting button activates an advanced setting screen.

In another aspect of the present invention, wherein the advanced setting screen comprises a section A data field and a section B data field.

In another aspect of the present invention the program product further causes the machine to: automatically translate the received message into a translated message; display the translated message in the section A data field; receive a new message from the user in the section B data field; automatically translate the new message; and send the translated message to the remote computer.

These and other features, aspects and advantages of the present invention will become better understood with reference to the following drawings, description and claims.

### BRIEF DESCRIPTION OF THE DRAWINGS

FIG. 1 is a screenshot of an embodiment of the invention;

FIG. 2 is a screenshot of the invention of FIG. 1 showing the minimized section B data field 14;

FIG. 3 is a flowchart of the invention; and

FIG. 4 is a screenshot of another embodiment of the invention showing an advanced configuration window layout.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention.

Broadly, an embodiment of the present invention provides a system for translating a message. The system for translating a message includes a computer and a software program. The software program automatically receives and translates a message sent from a remote computer to a selected language. The software also translates outgoing messages to the remote computer.

In certain embodiments the system provides an easy way to utilize translation tools to translate one language into another, enabling certain people to communicate with each other. The software program may use an automated copy and paste system which allows two people who speak different languages to have continual fluid back and forth communication.

In certain embodiments, the software may automatically translate a message from one language to another, such as from English to Spanish. In certain embodiments, the translation may be sent from a first party to a second party, without the first party seeing the translation. In such embodiments, the first party only sees the message in their native language which may be sent from a party that sent the message in a different language. This is because the software may translate the message automatically. Even though the first party sends the second party an e-mail in a first language, the second party only receives the message in a second language and vice versa.

The system may include a computer and a software program. The computer may include, but is not limited to, a desktop, laptop, and a smart device such as a tablet or smart phone. The computer may connect with and receive a message from a remote computer. The computer may connect with the remote computer via the internet, intranet, extranet, host server, internet cloud, Bluetooth® and the like. The computer may receive a message from the remote computer in the form of an e-mail, social media comment, phone texting, and the like.

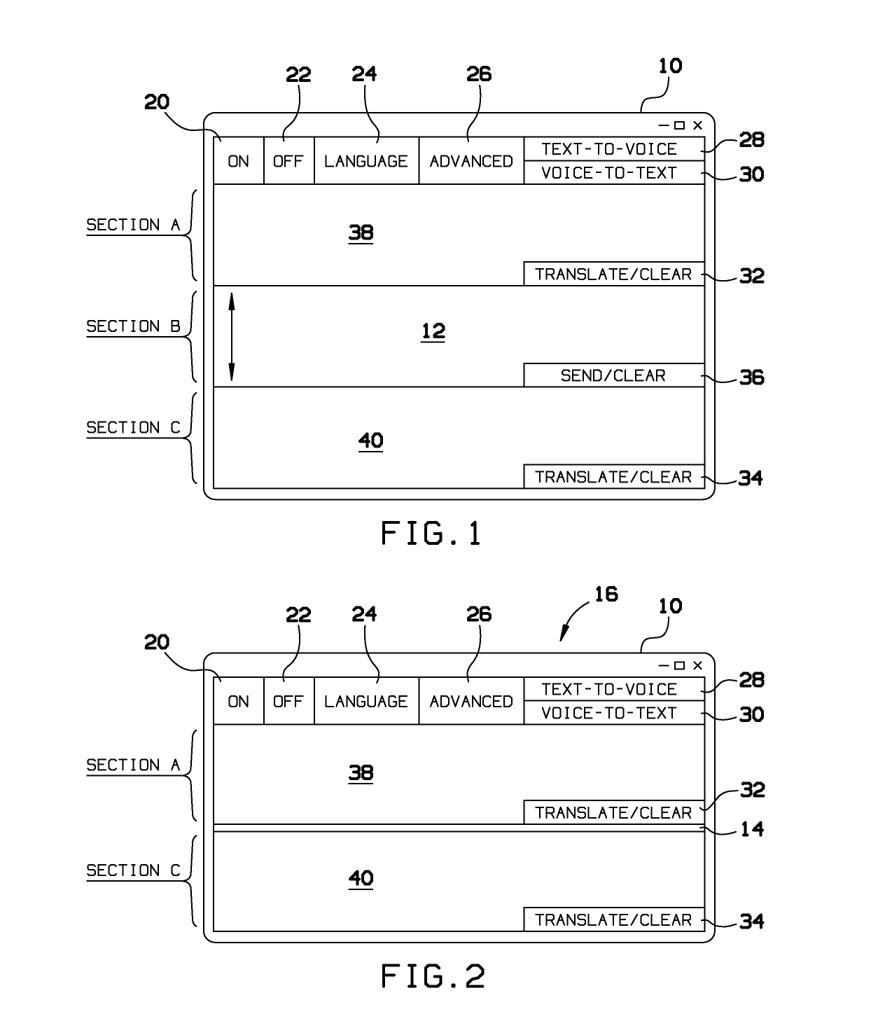

In certain embodiments, the software program may be called “eTranslator.” Referring to FIGS. 1 through 4, the software program may include an application window 10 which may include multiple interactive switches in which a user may activate. For example, the switches may include an on button 20, an off button 22, a language selection button 24, an advanced configuration selection button 26, a text to voice button 28, a voice to text button 30, a translate and/or dear button 32, 34, and a send and/or dear button 36. In an embodiment of the invention, the application window may include a section A data field 38, a section B data field and a section C data field 40. The section B data field may be in a maximized state 12 or a minimized state 14. When the section B data field is in the minimized state 14, there may be an application window displaying the minimized state 16.

A first user may receive a message on their computer from a second user on a remote computer. The message may be in the section A data field 38. The message may be in a language that is foreign to the first user. The section B data field may be in a minimized state at this point. In certain embodiments, the first user may turn on the translator using the on button 20. Turning on the on button 20 activates the program and allows the program to translate. The first user may then activate the language selection button 24. The first user may select a desired language so that the software may be directed to translating the message into the desired language.

Once the language has been selected, the message may be automatically cut and pasted into an unseen translation program or software. The unseen translation program may either be a separate program or a program embedded within the eTranslator program. In other embodiments, the user may press the translate button in the section A data field to activate the automatic copying or cutting and pasting into the translation program. Once the message has been translated into the selected language, the message may then automatically be pasted into the section B data field. The section B data field may then be in the maximized state 12. The first user may then read the translated message.

For the first user to send back a new translated message, a similar process may occur. The first user may type their response to the message in the section C data field 40. Since this example is a response to an incoming message, the first user may not have to select the language in the language selection button 24. However, if the first user initiates the first message, the user may use the language selection button 24. Once the message has been typed into the section C data field 40, the user may press the translate button 34. The message may be automatically cut and pasted into the translator program and is translated into the second user's language or into the selected language. Once the translator program has translated the message, the translated message may be pasted into the section B field 12. Then the user may press the send button 36 in the section B field 12 to send the message to the second user. The system disclosed above provides a continuous and seamless flow of bilingual conversation.

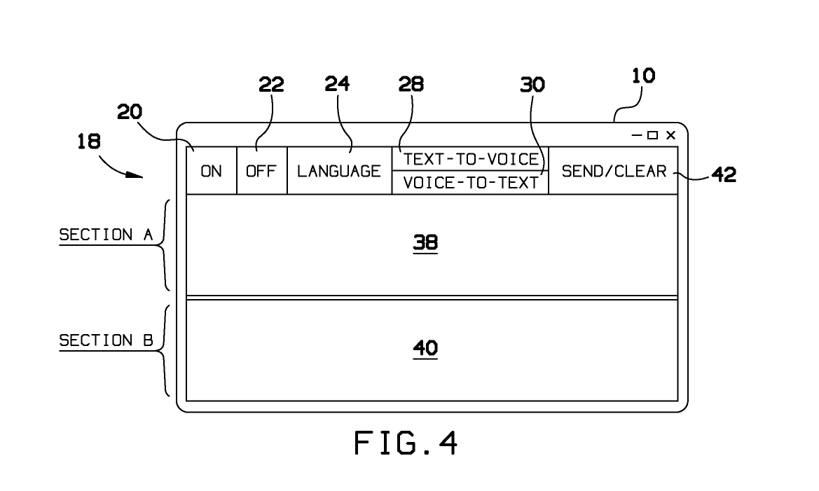

Referring to FIG. 4, the eTranslator may be in an advanced configuration layout 18. The advanced configuration layout 18 allows users to send and receive messages in foreign languages without ever seeing the translation of the message. For example, a user may set the language that all incoming e-mails may be translated into. Incoming e-mails may be automatically translated and appear in the section A data field 38. All outgoing messages in response to the incoming messages may be typed out in the section B data field 40. The user may activate the send button 42 in the advanced settings and the advanced configuration layout 18. The outgoing message may be automatically translated into the language of the received e-mail. Therefore, the advanced configuration may automatically send the translated message to the second user without the first user seeing the translation.

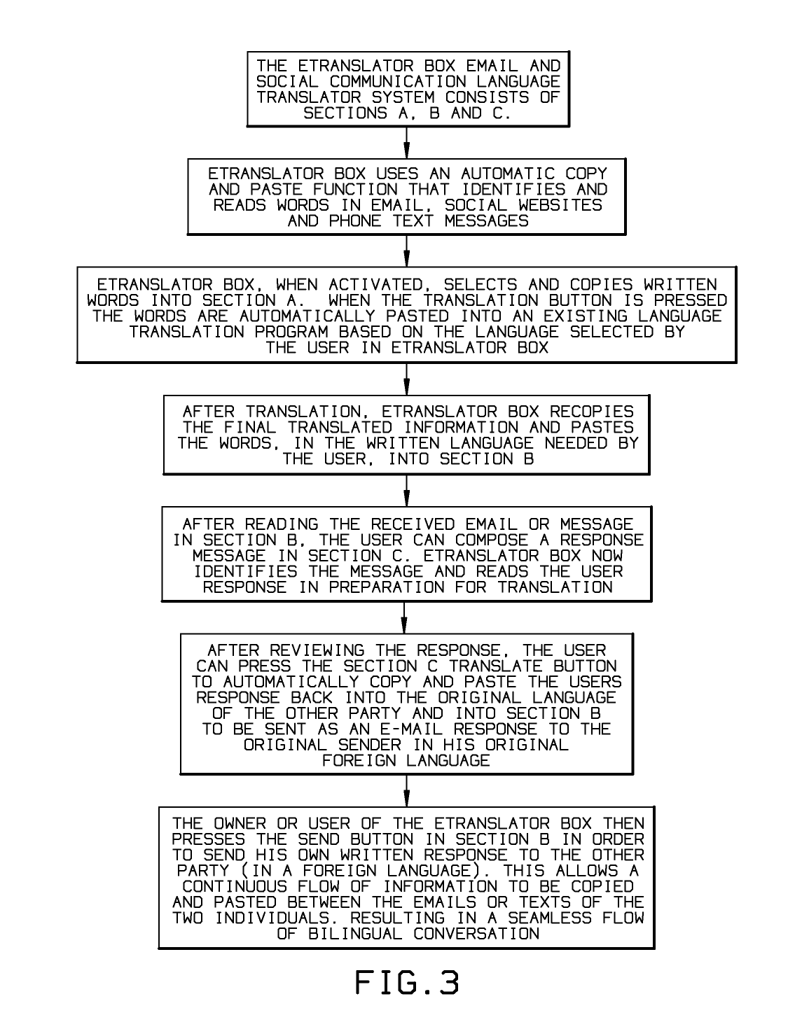

Referring to the flowchart of FIG. 3, the eTranslator box email and social communication language translator system may consist of sections A, B and C. The eTranslator box uses an automatic cut and paste function that identifies and reads words in email, social websites and phone text messages. The eTranslator box, when activated, may select and copy written words into section A. When the translation button is pressed, the words are automatically pasted into an existing language translation program based on the language selected by the user in the eTranslator box. After the translation, eTranslator box recopies the final translated information and pastes the words, in the written language needed by the user, into section B. After reading the received email or message in section B, the user may compose a response message in section C. The eTranslator box now identifies the message and reads the user response in preparation for translation. After reviewing the response, the user can press the section C translate button to automatically copy and paste the users response back into section B to be sent as an e-mail response to the original sender in his original foreign language. The owner or user of the eTranslator box then presses the send button in section B in order to send his own written response to the other party (in a foreign language). This allows a continuous flow of information to be cut and pasted between the emails or texts of the two individuals. This results in a seamless flow of bilingual conversation.

In certain embodiments the system may be used for e-mails, as an application for any social network, such as LinkedIn®, Facebook®, Twitter® and the like, or for text messages. However, the system is not limited to such platforms and may be used for any application that includes translating digitally written words or texts to provide bilingual communication. For example, the system may be used in classrooms, as learning games, and a method of advertising to expansive amounts of potential customers.

A method of using may include the following. A first user speaking a first language (i.e. Chinese) sends a second user speaking a second language (i.e. English) an e-mail that may be written in the first language. The second user opens their e-mail to find that it was written in the first language. The second user may first click the on/off button of the software program to turn it on. The second user may then click the language button and chooses the first language to second language translation (i.e. Chinese to English). The second user's software then automatically translates and transfers the first user's e-mail from section A into section B. The second user may then read the e-mail from the first user, which is now translated into the second language. The second user may then type a response in the second language in section C. The user may then select the translate button, and the e-mail appears translated into the first language in section B. The second user may then click the send button in section B, and the first user receives the e-mail in the first language. Therefore, to keep the conversation going, the first user may make another response to the second user in the first language. The second receiver again receives the e-mail in the first language in section A and the whole cycle begins again.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present invention discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A system for translating messages, comprising:
a machine; and
a program product comprising machine-readable program code for causing, when executed, the machine to perform the following process steps:
receiving a message from a remote computer;
providing the message to a user;
prompting the user to select a language translation preference;
receiving the language translation preference as a selected language;
translating the received message into the selected language;
receiving a new message from the user;
automatically translating the new message into the selected language; and
sending the new message translated into the selected language to the remote computer.

2. The system of claim 1, wherein the program product further causes the machine to automatically cut and paste at least one of the received message and the new message into a translation program.

3. The system of claim 2, wherein the program product further causes the machine to provide a section A data field, a section B data field, and a section C data field.

4. The system of claim 3, wherein the section A data field comprises a translate button, the section B data field comprises a send button, and the section C data field comprises a translate button.

5. The system of claim 4, wherein the program product further causes the machine to:
display the received message in the section A data field;
prompt the user to select the translate button in the section A data field;
receive a translate command from the user;
cut and paste the received message into the translation program, wherein the received message is translated into a translated message; and
cut and paste the translated message into the section B data field wherein the user views the translated message.

6. The system of claim 4, wherein the program product further causes the machine to:
receive the new message from the user in the section C data field;
prompt the user to select the translate button in the section C data field;
cut and paste said new message into the translation program, wherein the new message is translated into a translated new message; and
cut and paste the new translated message into the section B data field wherein the user views the translated message.

7. The system of claim 6, wherein the program product further causes the machine to: prompt the user to select the send button in the section B data field; and send the translated message to the remote computer.

8. The system of claim 2, wherein the program product further causes the machine to: display an advanced settings button wherein the advanced setting button activates an advanced setting screen.

9. The system of claim 8, wherein the advanced setting screen comprises a section A data field and a section B data field.

10. The system of claim 9, wherein the program product further causes the machine to:
automatically translate the received message into a translated message;
display the translated message in the section A data field;
receive a new message from the user in the section B data field;
automatically translate the new message; and
send the translated message to the remote computer.
